(19) United States
(12) Patent Application Publication
(10) Pub. No.: US 2022/0169662 A1
(43) Pub. Date: Jun. 2, 2022

(54) A POLYMER COATED METAL-ORGANIC FRAMEWORK

(71) Applicant: SHELL OIL COMPANY, HOUSTON, TX (US)

(72) Inventors: Tao LI, Shanghai (CN); Lihan CHEN, Shanghai (CN)

(21) Appl. No.: 17/441,767

(22) PCT Filed: Apr. 7, 2020
(86) PCT No.: PCT/EP2020/059871

§ 371 Date: Sep. 22, 2021

(30) Foreign Application Priority Data
Apr. 12, 2019 (CN) PCT/CN2019/082372

(51) Int. Cl. C07F 1/08; C07F 1/00; C09D 133/10; C09D 133/08

(52) U.S. Cl. CPC C07F 1/08; C07F 1/005; B01J 20/226; C09D 133/08; C09D 133/10

(57) ABSTRACT

The present invention relates to metal-organic framework characterized in that it comprises a polymer coating; further the invention relates to a process for the preparation of said polymer-coated metal-organic framework and a process for recycling after degradation. The polymer coated MOFs of this invention find application in a broad range of technologies and therapeutic areas.

### FIELD OF THE INVENTION

The present invention relates to a metal-organic framework comprising a polymer coating, a use thereof, a process for preparing such polymer coated metal-organic framework, and a process for recycling the same.

### BACKGROUND OF THE INVENTION

Metal-organic frameworks (herein after MOFs) are a large class of porous materials constructed from metal/metal cluster building blocks linked by organic linkers through coordination bonds. Due to the availability of a wide selection of metals, metal coordination modes, and the power of organic synthesis, their combinations have led to the emergence of tens of thousands of MOF structures in two decades. Their potential in application fields such as gas storage, gas separation, catalysis, sensing, bioimaging, therapeutics etc. has been widely acknowledged.

With the rapid evolution in this field, now the concept of “tailor-made” porous materials with desired pore sizes, pore geometry, pore chemistry and even mechanical properties, has been made possible. However, a significant drawback of MOF materials is their relatively low stability towards water, acids, bases and other aggressive chemicals compared to conventional porous materials such as zeolites and porous carbons. This drawback severely limits their further deployment in many realistic industrial applications. For example, many MOF materials have shown great potential for post-combustion CO₂ capture. However, due to the huge quantity of materials needed for such application, potential CO₂ sorbent materials are expected to have long term durability in order to reduce the cost and to limit their environmental impact. Unfortunately, the generally high humidity of flue gas streams has a negative impact not only on the CO₂ uptake capability of most MOF materials but also on their durability. One option to reduce the cost of sorbent materials is to recycle them after use.

A traditional way to recycle a MOF after degradation is to first digest it into a monomer mixture (metal ions and organic linkers) followed by multiple separation and purification processes to obtain metal salts and organic linkers in pure form. Then these monomers are again mixed under appropriate condition to allow the nucleation and growth of the MOF to occur. Finally, the obtained MOF crystals are separated and processed for the second use. Obviously, this is a costly and tedious procedure of recycling. Moreover, typical MOF synthetic conditions require the use of excess amounts of reagent and solvent resulting in a very low efficiency.

There is a need for MOF materials with a higher durability/recoverability, and for a more efficient and less costly way for recycling the materials.

### SUMMARY OF THE INVENTION

The present disclosure provides a solution to said problems and needs. Accordingly, the present invention relates to a metal-organic framework comprising a polymer coating. Further, the present invention relates to a process for the preparation of a metal-organic framework comprising a polymer coating, comprising a controlled radical polymerization step.

The polymer-coated MOFs of this invention can be broadly applied to replace their neat MOF counterparts to extend their mechanical and chemical durability. Accordingly, a further aspect of the invention relates to the use of the polymer-coated MOFs in gas storage, gas separation, gas capture, catalysis, sensing, bioimaging and therapeutics, and in particular, the use thereof in direct air capture, post-combustion CO₂ capture, and methane storage.

Another aspect of the present invention relates to a process for (in situ) recycling of degraded polymer-coated metal-organic frameworks, comprising vapor or liquid assisted annealing or a solvothermal reaction. The presently claimed recycling process eliminates the tedious procedures needed in a traditional recycling process and replaces them with a one-step recrystallization process. This process can be used to significantly extend the operation lifespan of MOF-based sorbent materials by repetitive recycling.

### DESCRIPTION OF THE DRAWINGS

(Note: the annotation “RE” means recrystallized and “DE” means degraded)

Scheme 1. Synthesis scheme of random copolymer 1 (RCP1).

FIG. 1. Schematic illustration of the degradation and recrystallization process of a MOF particle within a polymeric shell.

FIG. 2. TEM images of (A) HKUST-1@PS; (B) HKUST-1@PS-DE; and (C) HKUST-1@PS-RE.

FIG. 3. Powder X-ray diffraction patterns of HKUST-1@PS, HKUST-1@PS-DE, and HKUST-1@PS-RE.

FIG. 4. CO₂ adsorption isotherms of HKUST-1@PS, HKUST-1@PS-DE, and HKUST-1@PS-RE at 298 K. Solid and hollow symbols represent adsorption and desorption points respectively.

FIG. 5. Normalized CO₂ uptake capacity of HKUST-1@PS (also referred to as HKUST-1@xPS, “x” meaning crosslinked) after 5 degradation-recrystallization cycles at 298 K.

FIG. 6. Comparative example. TEM images of (A) HKUST-1 and (B) HKUST-1-DE (i.e. MOF particles without polymer coating).

FIG. 7. Comparative example. Powder X-ray diffraction patterns of HKUST-1, HKUST-1-DE, and HKUST-1-RE.

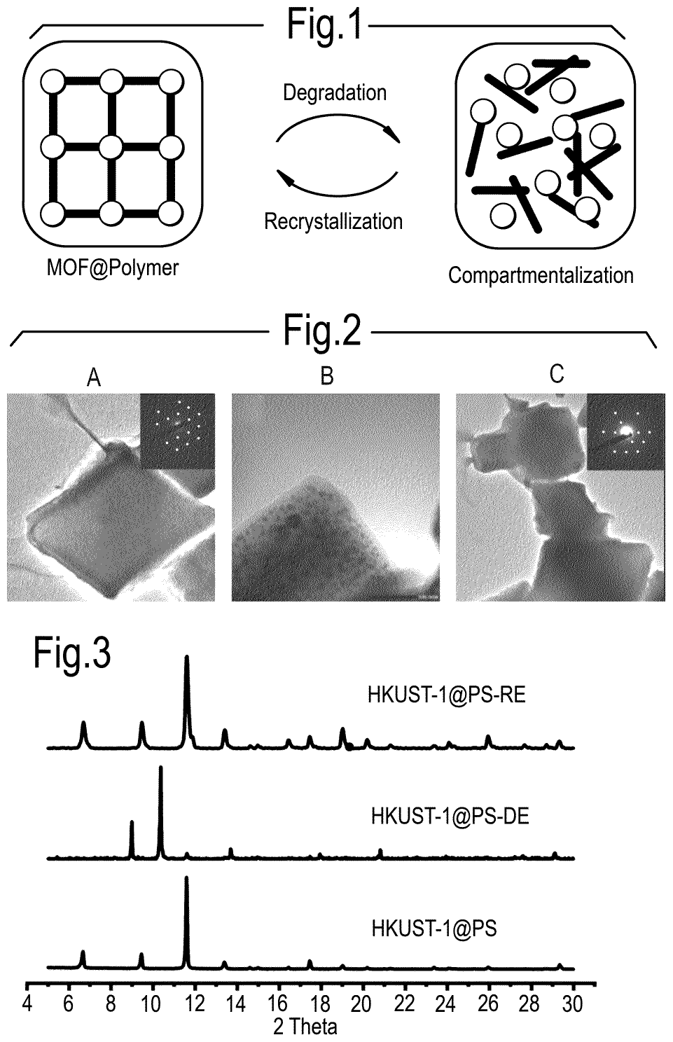

### DETAILED DESCRIPTION OF THE DISCLOSURE

The present disclosure relates to metal-organic frameworks (MOFs), which are compounds consisting of metal ions or clusters coordinated by organic ligands (linkers) to form one-, two-, or three-dimensional structures. These MOFs are typically crystalline materials meaning that their exact structures can be obtained through techniques like single crystal X-ray diffraction or powder X-ray diffraction. They possess many properties analogous to traditional porous materials such as zeolites and porous carbons. These include intrinsic microporosity/mesoporosity and high BET surface area from 10 m²/g up to 7000 m²/g. Additionally, MOFs possess unique properties that traditional porous materials do not have. These include modular synthesis meaning that the pore size, shape and chemical environment can be systematically designed by judicious selection of organic linkers and metal coordination modes.

The MOFs used for present disclosure can be synthesized by a wide variety of methods that are commonly known in the art. These include but not limited to hydrothermal synthesis, solvothermal synthesis, mechanosynthesis, microwave assisted synthesis, spray-drying synthesis, continuous flow synthesis etc.

The MOFs used for present disclosure comprise one or more metal ions or metal clusters and one or more organic linkers. The metal ions or metal clusters can be any metal selected from the periodic table and preferably metals from group IIA, IIIA, first row transition metals, second row transition metals, actinides, and lanthanides. Preferred metals are selected from Al, Cr, Zr, Sc, Hf, Ti, Cu, Co, In, Fe, Ni, Zn and V. Preferred metals are Cu and Zn.

The organic linkers used in the MOFs are small organic molecules with two or more coordinating functional groups and are not particularly limited. Preferred functional groups are carboxylic acids (carboxylates), nitrogen containing five/six-member rings (pyridine, imidazole, pyrazole, pyrazine, 1,2,3-triazole, 1,2,4-triazole, tetrazole etc.), and phenols, etc. More preferred linking ligands for linking the adjacent metal building units in the MOF structure are carboxylate-based ligands, which include 1,3,5-benzenetribenzoate (BTB), 1,4-benzenedicarboxylate (BDC), cyclobutyl 1,4-benzenedicarboxylate (CB BDC), 2-amino 1,4 benzene-dicarboxylate (H2N-BDC) , 4,5,9,10-tetrahydropyrene-2,7-dicarboxylate (HPDC), terphenyl dicarboxylate (TPDC), 2,6-naphthalene dicarboxylate (NDC), pyrene 2,7-dicarboxylate (PDC), biphenyl dicarboxylate (BDC), and any di-, tri-, or tetracarboxylate containing phenyl rings.

The average MOF particle size is from 10 nm to 1 mm and preferably from 100 nm to 1 μm, more preferably from 100 μm to 10 μm, and in particular from 10 μm to 1 μm. The particle size is identified by scanning electron microscopy (SEM).

The BET surface area of the MOFs used in this disclosure range from 10 m²/g to 7000 m²/g and preferably from 100 m²/g to 4000 m²/g. The BET surface area is identified using N₂ adsorption isotherm data.

The pore size of the MOFs used in this disclosure range from 0.3 nm to 10 nm and preferably from 0.3 nm to 1 nm.

According to the present disclosure, it was found that by coating the MOF particle surface with a thin layer of polymer through controlled radical polymerization, the metal ions and organic ligands are well-confined within the polymeric boundary to give relatively stable MOF@polymer composites (FIG. 2A).

According to the present disclosure, the MOF particles need to be coated with a layer of polymer in order to confine the metal ions and organic linker molecules within that were used for the construction of the MOF structure and, in addition, to ensure optimal recrystallization efficiency.

The polymer coatings used in this disclosure are conventional polymer coatings and not particularly limited. Suitable examples include styrene, acrylate, methacrylate polymer coatings, etc. which can be synthesized using radical initiated polymerization techniques; further polyimide, polysulfone, polyether-sulfone, polyamide polymer coatings, etc. Preferred examples of the polymer coating are polystyrenes, polyimides, polysulfone. FIG. 2A shows an example of HKUST-1@PS in which HKUST-1 was coated by a layer of polystyrene with good uniformity.

The “HKUST” terminology used herein is in accordance with the terminology introduced by the Hong Kong University of Science and Technology which first appeared in (10.1126/science.283.5405.1148).

The thickness of the polymer coating preferably ranges from 1 nm to 1 μm and particularly from 2 nm to 100 nm.

Further, the invention relates to a process for preparing a metal-organic framework comprising a polymer coating, comprising a controlled radical polymerization step, preferably using a technique selected from atom transfer radical polymerization (ATRP), reversible addition-fragmentation chain-transfer polymerization (RAFT), or nitroxide-mediated radical polymerization (NMP). Particularly, the process used for coating the polymer comprises controlled radical polymerization techniques using acrylates, methacrylate, styrenic monomers etc.

According to the present disclosure, it was further found that even after degradation of the polymer coated MOFs (MOF@polymer) under harsh environment, no apparent leaching of components from the MOF structure was observed due to the barrier effect of the polymer shell (FIG. 2B). Subsequent vapor or liquid assisted annealing or solvothermal reaction surprisingly led to the recrystallization of the MOF particles within the polymeric shell (FIG. 2C) thereby restoring the shape, crystallinity, and sorption properties of the MOF. It was found that such degradation-recrystallization process can be repeated several times. Therefore, the present disclosure further relates to a process for recycling of degraded polymer-coated metal-organic frameworks, comprising vapor or liquid assisted annealing or a solvothermal reaction.

A typical vapor assisted annealing process is carried out by exposing a polymer-coated metal-organic framework sample to an organic vapor environment under heating conditions, generally above the boiling point of the solvent used. A preferred heating temperature range is from 60-200° C. Common organic solvent selections include methanol, ethanol, propanol, dimethylformamide, N-Methyl-2-pyrrolidone, and dimethylacetamide etc. and their combinations. Preferably methanol, ethanol and dimethylformamide. Additives may be added to assist the dissolution of linkers and metal ions. Examples of additives include trifluoracetic acid, acetic acid, hydrochloric acid, and formic acid etc.

A typical liquid assisted annealing process is carried out by the addition of a small quantity of organic solvent to a polymer-coated metal-organic framework sample followed by heating, suitably in a temperature range from room temperature (25° C.) to 200° C. The solvent and additive selection is similar to that of vapor assisted annealing process. The quantity of the solvent is typically quite small, with volume comparable to the solid. Specifically, the solid-liquid volumetric ratio is typically in the range between 1:10 and 10:1. This process can be used to regenerate polymer coated MOF-based sorbent materials on-site with high efficiency and low cost in a short amount of time thereby greatly extending the lifespan of said MOF materials.

In contrast to the polymer coated MOF structures of the present disclosure, non-coated MOF structures with similar MOF composition showed severe leaching issues, and further could not be recrystallized according to the procedures of the present disclosure.

Hereinafter the invention will be further illustrated by the following non-limiting examples.

### EXAMPLES

### Experimental methods

1. Electron Microscopy

Transmission electron microscopy (TEM) was conducted by JEM-1400Plus TEM (120 kV) and JEM 2100 plus (200 kV). Briefly, 10 μL Sample-Methanol solution was directly deposited on a carbon coated TEM grid for 30 seconds. Then, excessive solution was wicked away with pieces of filter paper. Then the grid was dried for 15 minutes under 70° C.

2. Powder X-Ray Diffraction (PXRD)

PXRD patterns were collected in the 2θ range of 5-30° at room temperature on a Bruker D8 X-ray diffractometer with Cu Kα radiation (λ=1.54184 Å) at a scan rate of 2°/min and a step size of 0.02°

3. CO₂ Adsorption-Desorption Analysis

CO₂ adsorption-desorption analysis was performed with a volumetric adsorption analyzer (e.g. BELSORP-max II or Quantachrome iQ or Micromeritics ASAP 2020). All samples were pre-exchanged with volatile organic solvents (e.g. MeOH) to remove pre-existing high boiling point solvents. Then the samples were activated at 120° C. for 10 h under constant vacuum.

### Example 1

### Synthesis of Random Copolymer (RCP1) P(vbpt-r-ba-r-aa) (wherein ba: butyl acrylate; aa: acrylic acid; and vbpt: S-(4-vinyl) benzyl S′-propyltrithiocarbonate) (see Scheme 1)

MOF Preparation HKUST-1

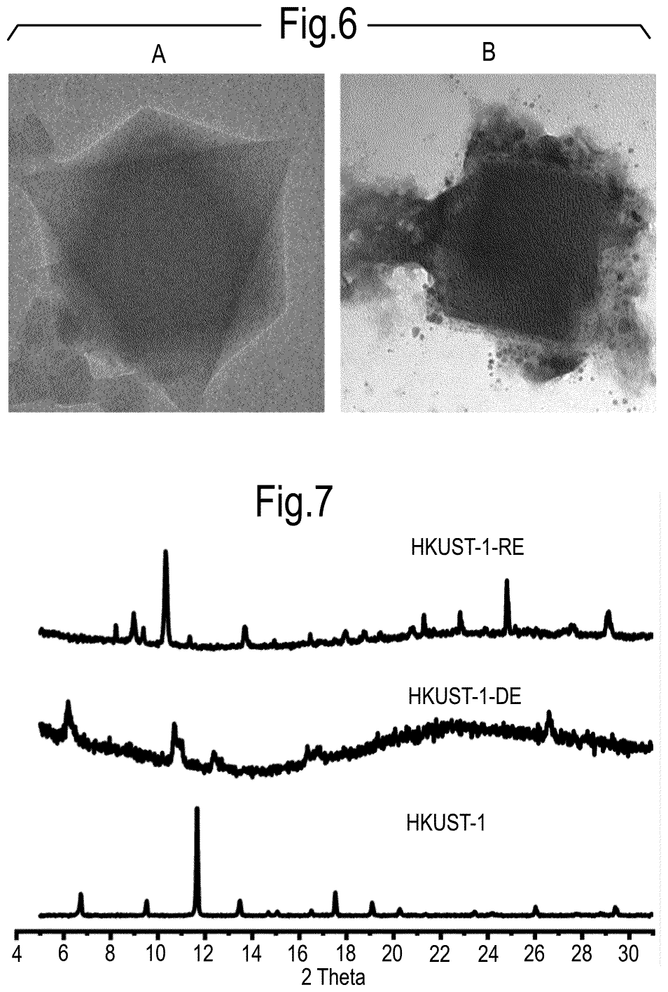

12.2 g of Cu(NO₃)₂.3H₂O and 2.9 g of benzene-1,3,5-tricarboxylic acid was dissolved in 25 ml of dimethylsulfoxide (DMSO) under 65° C. for 30 min. The solution was then injected into 250 ml of methanol containing 2.5 g of polyvinylpyrrolidone under vigorously stirring at 55° C. for 90 min. The products were harvested by centrifuging and washing twice with methanol, and finally dispersed in methanol for further use. FIG. 6A shows the TEM image of the as synthesized HKUST-1

Preparation of HKUST-1@PS

Dissolve 1 g of HKUST-1 and 250 mg of P(vbpt-r-ba-r-aa) in 15 ml of dichloromethane (DCM), the mixture is sealed in a small capped vial and sonicated to get well dispersed. After 12 hours of incubation, the particles were washed twice with toluene and then again dispersed in 15 ml of toluene. Then 4.5 ml of styrene, 1.125 ml of divinylbenzene (DVB) and 15 mg of azobisisobutyronitrile (AIBN) were added to the solution. Three freeze-pump-thaw cycles were applied to the solution to remove dissolved O₂. Then the ampule was sealed under vacuum. The polymerization reaction was carried out at 75° C. for 1.5 h under constant stirring. FIG. 2A shows is the TEM image of HKUST-1@PS. The PXRD pattern of HKUST-1@PS is shown in FIG. 3.

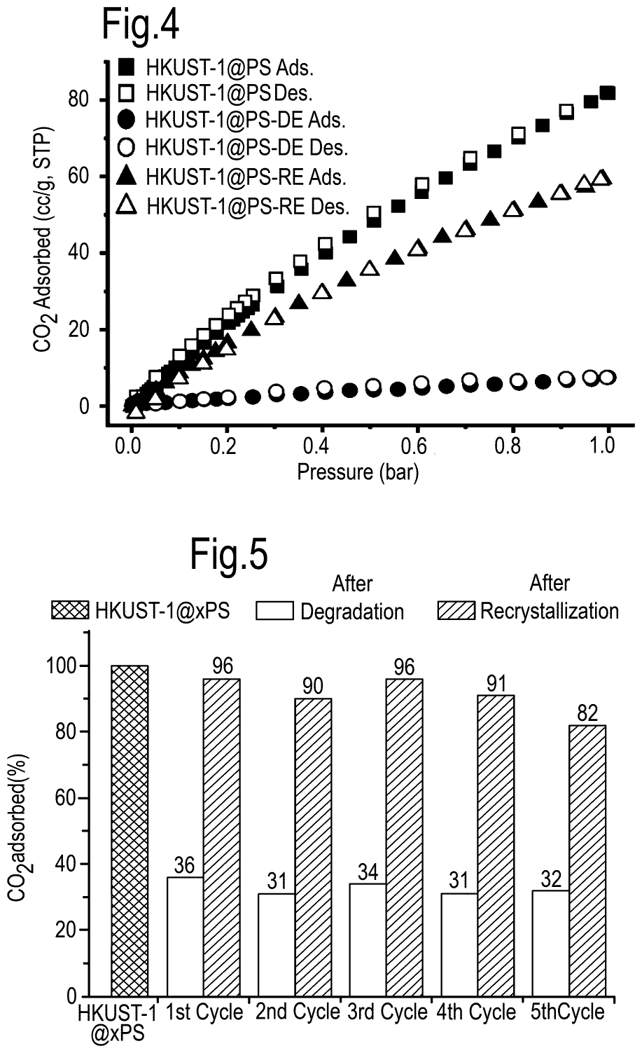

The CO₂ uptake capacity of HKUST-1@PS at 298 K is 83 cc/g (FIG. 4).

CO₂ uptake is measured by using Brunauer-Emmett-Teller (BET) theory. CO₂ uptake isotherms were obtained using a volumetic sorption analyzer. Commonly used commercial modes include Belsorb MAX II, Quantachrome iQ, Micromeritics ASAP 2020 etc. Typically, ˜30-50 mg of MOF sample was loaded into a glass sample cell and then activated at 120° C. for 10 h under a constant vacuum. The sample cell was then loaded on to the sorption analyzer for subsequent analysis.

### Example 2

Degradation and Recrystallization Experiment

To mimic the degradation process in industry, 150° C. water vapor environment was used to facilitate the degradation process of HKUST-1@PS. The degraded product was therefore named HKUST-1@PS-DE.

After degradation, the powder X-ray diffraction pattern shows the disappearance of HKUST-1 characteristic peaks by replaced by a new phase.

The recrystallization process was carried out by exposing HKUST-1@PS-DE to an appropriate solvent vapor under heat. The recrystallized product HKUST-1@PS-RE showed complete regeneration of HKUST-1 crystallinity.

### DETAILED DESCRIPTION

Degradation HKUST-1@PS by H₂O at 150° C.

A HKUST-1@PS powder sample (˜15 mg) was placed on a glass slide and the slide was loaded into a Teflon-lined stainless-steel hydrothermal reactor containing ˜1 ml of water. The glass slide was suspended above the water without touching. The reactor was placed in a 150° C. oven overnight. After cooling the reactor, the sample was taken out, collected and denoted as HKUST-1@PS-DE. The PXRD pattern of HKUST-1@PS-DE is shown in FIG. 3. Its CO₂ uptake capacity at 298 K is 91% less than that of HKUST-1@PS (FIG. 4). The TEM image shows that the HKUST-1 particles transformed into another smaller crystalline particles (FIG. 2B).

Recrystallization of HKUST-1@PS-DE

HKUST-1@PS-DE (˜15 mg) was placed on a glass slide and loaded into a Teflon-lined stainless-steel hydrothermal reactor containing ˜1 ml of an ethanol/trifluoroacetic acid (TFA) mixture (ethanol:TFA=98:2). The glass slide was suspended above the solvent layer without touching. The reactor was placed in a 100° C. oven overnight. After cooling, the sample was taken out, collected and denoted as HKUST-1@PS-RE. The PXRD pattern of HKUST-1@PS-RE is shown in FIG. 3 which indicates a successful recrystallization of HKUST-1. Its CO₂ uptake capacity at 298 K is 73% of that of HKUST-1@PS (FIG. 4). The TEM image shows that the HKUST-1 particles reformed in single crystal fashion (FIG. 2C).

Degradation-Recrystallization Cycling of HKUST-1@PS

HKUST-1@PS was degraded and recrystallized using aforementioned procedures for 5 cycles. Their CO₂ uptake capacity at 1 bar, 298 K was recorded and plotted in FIG. 5.

### Example 3

Comparative Example—Non-Polymer Coated MOF

Degradation HKUST-1 by H₂O vapor at 150° C. A HKUST-1 sample (˜15 mg) was placed on to a glass slides and the slide was loaded into a Teflon-lined stainless-steel hydrothermal reactor containing ˜1 ml of water. The glass slide was suspended above the water without touching. The reactor was placed in a 150° C. oven overnight. After cooling the reactor, the sample was taken out, collected and denoted as HKUST-1-DE. The PXRD pattern of HKUST-1-DE is shown in FIG. 7. Thus, the recrystallization process did not lead to the recovery of HKUST-1 as shown from the PXRD pattern. The TEM image shows leaching of monomers (FIG. 6B).

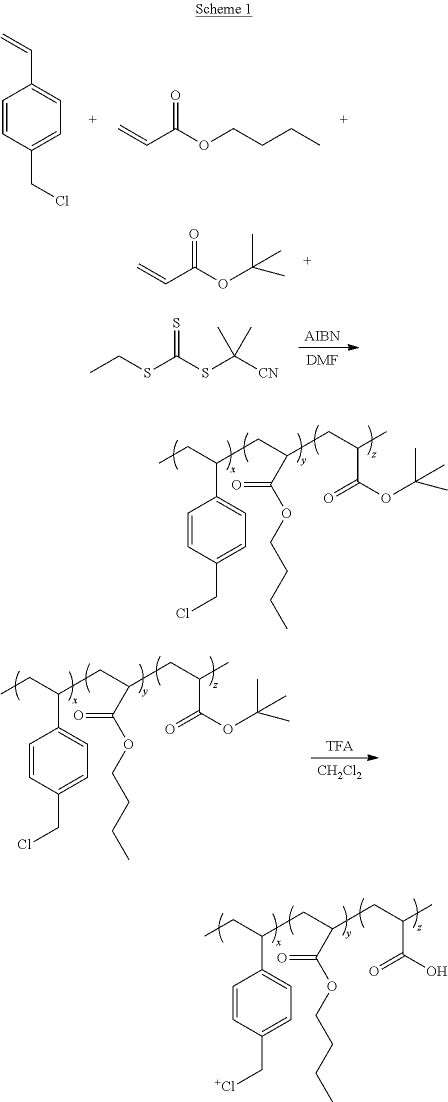

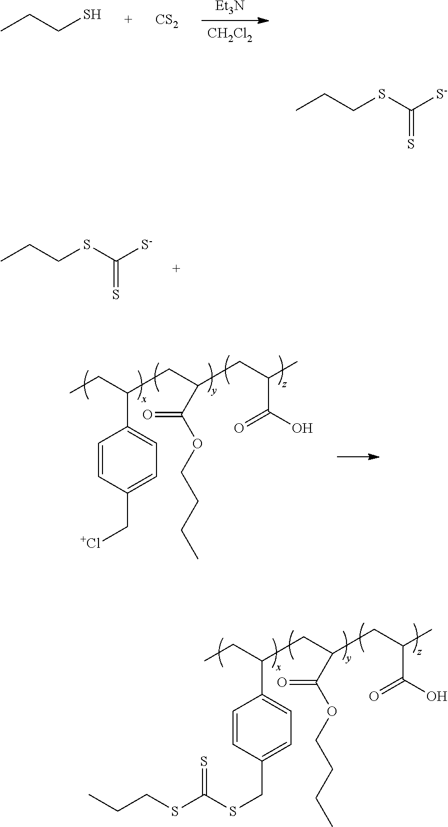

We claim:

1. A metal-organic framework characterized in that it comprises a polymer coating.

2. The metal-organic framework of claim 1, wherein the metal-organic framework comprises one or more metal ions or metal clusters and one or more organic linkers, the metal ions or metal clusters being of any metal selected from the periodic table, preferably a metal from group IIA, IIIA, first row transition metals, second row transition metals, actinides, and lanthanides.

3. The metal-organic framework of claim 2, wherein the organic linkers are small organic molecules with two or more coordinating functional groups.

4. The metal-organic framework of claim 1, wherein the BET surface area ranges from 10 m²/g to 7000 m²/g.

5. The metal-organic framework of claim 1, wherein the pore size ranges from 0.3 nm to 10 nm.

6. The metal-organic framework of claim 1, wherein the polymer coating is selected from styrene, acrylate, and methacrylate polymer coatings, and further from polyimide, polysulfone, polyethersulfone, and polyamide polymer coatings.

7. The metal-organic framework of claim 1, wherein the polymer coating has a thickness of from 1 nm to 1 μm.

8. (canceled)

9. A process for the preparation of a metal-organic framework comprising a polymer coating, a controlled radical polymerization step.

10. A process for recycling of degraded polymer-coated metal-organic frameworks, comprising vapor or liquid assisted annealing or a solvothermal reaction.
